(19) United States
(12) Patent Application Publication
(10) Pub. No.: US 2009/0166456 A1
(43) Pub. Date: Jul. 2, 2009

(54) Method for Manufacturing a Multimaterial Component or Construction

(75) Inventors: Jussi Hellman, Helsinki (FI); Jari Liimatainen, Tampere (FI)

Correspondence Address: BUCHANAN, INGERSOLL & ROONEY PC, POST OFFICE BOX 1404, ALEXANDRIA, VA, 22313-1404, US

(73) Assignee: METSO MINERALS, INC., Helsinki (FI)

(21) Appl. No.: 12/227,784

(22) PCT Filed: May 25, 2007
(86) PCT No.: PCT/FI2007/050297

§ 371 Date: Dec. 10, 2008

(30) Foreign Application Priority Data
May 31, 2006 (FI) 20065366

(51) Int. Cl. B29C 39/10; B29C 71/02; B02C 17/22

(52) U.S. Cl. 241/179; 264/271.1; 241/183

(57) ABSTRACT

A method for manufacturing a multimaterial component or construction, whereby a multimaterial component or construction is manufactured comprising wear resistant material and elastomer material. The invention also includes use of a multimaterial component or construction manufactured with said method.

The present invention relates to manufacturing of a combined multimaterial component or construction of at least two different materials, at least one material thereof being an elastomer based material.

### BACKGROUND

Wear resistant constructions and components are used e.g. in equipment for reducing the size of rock, building or recycling material and in cutting and grinding processes of wood processing.

In these equipment and processes, the material pressed between the components or flowing against the surfaces of the constructions or components, wears the surfaces of the components to the extent depending on the surface pressure of the contacts, velocities, material characteristics of the component surfaces and the physical characteristics, like compressive strength and tribology characteristics of the material to be crushed and the impurities transported by the material. In other words, as well the movement of the material to be processed with respect to the surfaces of the components as the penetration thereof to the surface of the component has influence on the wear experienced by the component: The material moving with respect to the surfaces of the components causes cutting and grooving, and the material penetrating to the surface produces burrs on the affected area, that as a result of repeated procedure are easily loosened from the surface of the constructions and components by breakage, fatigue or formation of cuttings.

The intensity of the wear of the constructions and components in the different portions thereof and generally in the equipment is defined by the geometry of the equipment, states of motion of the components and the flow parameters of the material to be processed.

The usable lifetime of the constructions and components is in general tried to be increased not only by effecting the geometry and internal flow conditions of the equipment, but also particularly by choose of materials. The tribology characteristics of metallic wear protection materials of prior art are usually based on the advantageous alloying of the metals in question, and eventual adding of particles, on primary manufacturing processes and further processing, like heat treatments, whereby phases with better resistance of wear phenomena than usual will be formed in their microstructure as a combined effect of all these factors, said phases typically being hard but having often low toughness and fatigue resistance. As also other than tribology characteristics are required from the constructions and components, they usually cannot be manufactured totally of the materials having the microstructure described above, but it is often most advantageous to use in each construction or component also materials with other kinds of properties. Also the controlling of the form of the wear of the constructions and components e.g. for maintaining the geometry and internal flow model of the equipment may be easier, when certain portions or areas of the constructions and components are manufactured of materials different from each other.

The energy used by the equipment of the manufacturing processes, and the recyclability of their wear parts are significant in terms of environmental aspects, and the noise and vibration caused by the use of the machines and equipment are essential factors when evaluating the occupational safety in many branches of industry and the constraints of use and locating of industrial plants. From these points of view, significant advantages can be achieved by the use of rubber and synthetic elastomer materials for example in the equipment meant for reducing the size of rock, building or recycling material. Because of the stiffness, toughness and incompressibility of the vulcanized raw rubber or other corresponding cross-linked elastomers, metal parts with heavier density can be replaced in certain construction and wear parts, whereby the resulted lighter weight of the equipment and especially the moving parts thereof decrease the energy consumption of the processes. The vibration damping capability of the elastomers is excellent compared with any metallic material, thereby decreasing significantly the vibrations causing fatigue of the constructions and decreasing the sound stress of the environment. Also the recyclability of the constructions and components including elastomers is good due to the suitable separating processes and objects where recycled materials can be used.

A general problem when manufacturing multimaterial components is the adapting of parameters of the manufacturing processes subjected to the whole construction or component so that the properties of any material to be used will not be deteriorated, at least not below the acceptable level. When the process conditions are adapted according to the constraints of all materials forming the construction, the properties achieved by each single material often remain below the optimal target level of the respective material, and the performance of the component or construction is not as good as possible. Especially challenging is also to keep the dimension and shape tolerances of the parts and portions formed by different materials in the configuration of the constructions and components and in the treatments after that, experienced together by the materials differing from each other and their boundary. In the worst case, the different behavior, for example the different volumetric changes of the materials in contact with each other or joined together, can result in damage of the construction or component. Often in terms of as well the technical final result as the quality and the commercial exploitability, it is advantageous, if the manufacturing steps of the construction or component can be arranged and chosen so, that each material can be processed as far as possible separated, and joined to the assembly, when only a few of manufacturing steps are left representing less risks for the saving of the properties.

Several Patent publications, like EP0714704 B1, GB1288083, U.S. Pat. No. 4,293,014 and U.S. Pat. No. 4,402,465 have disclosed wear parts and manufacturing methods thereof, wherein elastomers are utilized primarily as wear protection elements or portions in constructions and components, where metallic materials have only been used as bonding elements. Patent publication U.S. Pat. No. 4,848,681 discloses a lining application, wherein metal-elastomer composite constructions are used for wear protection, having, however, a shape or connection system not suitable for the thin-walled process equipment with pressing, cutting or grinding properties, meant in this connection.

In the construction parts disclosed by the Patent publication CH683605, the elastomers are used as supporting, filling or binding material, but the materials of the surface layer of said constructions are significantly different from the solutions disclosed in this connection. Also the ceramic materials proposed to be used in the Patent publication CN1082488 are not suitable to be used in the application described in this connection, due to their brittleness.

In many Patent publications, like GP639366, the damping properties of rubber and other elastomers have been brought out, but the disclosed constructions and materials are not suitable in the processes described in this connection.

### DESCRIPTION OF THE INVENTION

The solution in accordance with the present invention provides a multimaterial component or construction to be used typically as a wear part, manufactured by casting or vulcanizing elastomer material around ready-made wear protection pieces, said elastomer material binding the wear protection pieces to each other and to itself, thereby forming the frame of the wear part.

More precisely, the manufacturing method in accordance with the invention is characterized by what is stated in the characterizing part of claim 1, and the use of the multimaterial component or construction is characterized by what is stated in the characterizing part of claim 7 and 8.

The invention will be described in more detail in the following, with reference to the enclosed drawings, wherein Figures from 1A to 1F show a schematic view of one manufacturing method in accordance with the present invention for manufacturing a multimaterial component.

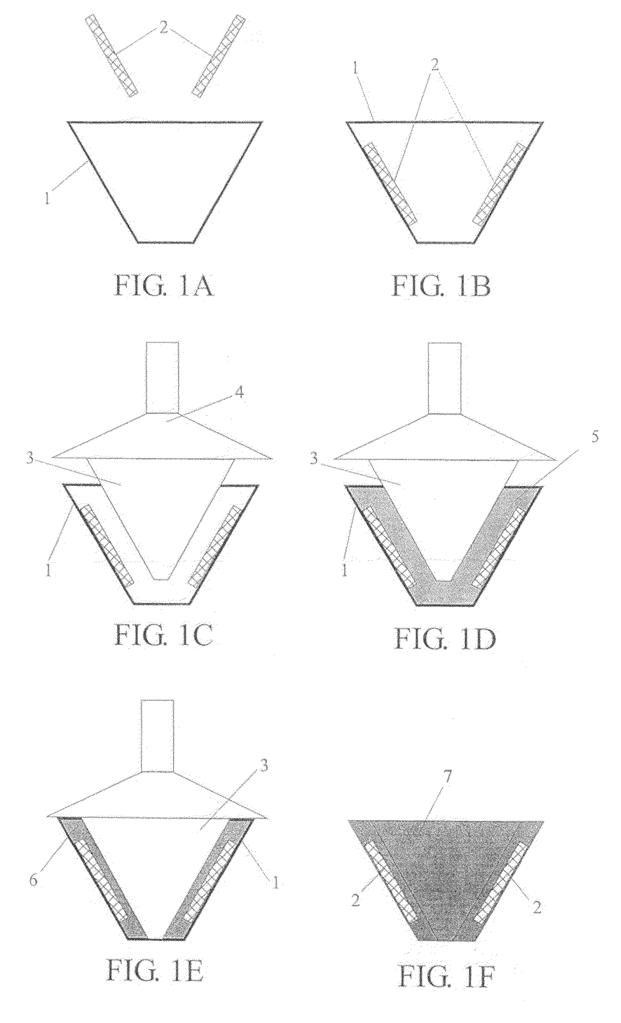

FIGS. 1A and 1B show a cross-sectional view of the first half 1 of an elastomer casting mold for a multimaterial component to be manufactured, said half being formed as a negative of the surface shape of the component to be manufactured, on the first side of the predetermined division plane. When choosing the material to be used as mold material and when dimensioning the wall thickness of the mold, the temperature during the casting process and the pressure in the mold, as well as the surface properties enhancing the loosening of the vulcanized elastomer from the mold must be taken into account. The dimensional tolerances for manufacturing the mold half are determined based on the tolerance requirements of the component to be manufactured, and the surface roughness of the mold is finalized so that the vulcanized elastomer can be easily removed from the opened mold.

FIGS. 1A and 1B show pieces 2 manufactured of wear resistant material, either of the same material each or of materials different from each other, and, independently, their properties can be the same or different from each other. These pieces 2 of wear resistant material are manufactured with a manufacturing method well suitable for each material, respectively, like casting or some other melt or powder metallurgic method. Pieces 2 can be manufactured directly to the final form or they can be after the primary manufacturing subjected to simple forming or machining for providing the final form. In addition to the wear resistant pieces, also other metallic or non-metallic pieces, meant for example for stiffening the volumetric portion formed of elastomer in the ready-made multimaterial construction or component, can be positioned in the mold. FIG. 1B shows an example of placing wear resistant pieces 2 into a mold for elastomer casting 1.

In the solution in accordance with the present invention, the pieces 2 formed of wear resistant material are preferably manufactured of an iron-based metal alloy having a carbon content of more than 1.9 percent by weight, hardness of more than 50 HRC, preferably more than 54 HRC, said alloy having in its microstructure a portion of more than 10% of metal carbides with a diameter of more than 3μ. The wear resistant pieces can advantageously also be of hard metal including tungsten, titan, tantalum, vanadium or chrome carbides or of an alloy of those, having as a binding agent pure or alloyed cobalt, nickel or iron so that the volumetric portion of the binding agent in the hard metal ranges from 3 to 40 percent by volume, preferably from 5 to 15 percent by volume.

In the solution in accordance with the present invention, the volumetric portion of the wear resistant material of the multimaterial component or construction to be manufactured is preferably more than 4% and the volume of the biggest single piece manufactured of wear resistant material is preferably not more than 25% of the total volume of the multimaterial component or construction.

After the primary manufacturing and eventual secondary forming, the wear resistant pieces 2 are heat treated, if necessary, eventually in process conditions different from each other, to provide the pieces with mechanical and tribology properties as favorable as possible. Typically the wear resistant pieces are of iron-based alloy, their microstructure including a big volumetric portion of hard phases, having a grain or particle size retarding the wear in the load caused by the using conditions of the construction or component to be manufactured.

Providing mechanical and tribology properties as favorable as possible for the wear resistant pieces 2 in this connection refers to the material-based choice of the hardening and tempering temperatures of the iron-based alloys having a carbon content or other alloying different from each other, so that the hardness and toughness achieved by each material are as favorable as possible in the object of use in terms of the load subjected to each separate piece of the multimaterial component, respectively.

The other half 3 of the elastomer casting mold of the multimaterial component, shown in FIG. 1C, is formed as a negative of the surface shape of the other side of the predetermined division plane of the component to be manufactured (the half opposite to the half 1). Also when choosing the material for the manufacturing of the other mold half 3 and when dimensioning the wall thickness thereof, the temperature and pressure in the mold during the casting process, as well as surface properties of the mold enhancing the loosening of the vulcanized elastomer, are taken into account. Likewise, the dimensional tolerances for the manufacturing of the mold half are determined based on the tolerance requirements of the component to be manufactured in the mold, and the surface roughness is finalized so that the vulcanized elastomer can be easily removed from the opened mold. In the example of FIG. 1C, a pressing means 4 is attached to the mold half 3, for generating at a later manufacturing step of the multimaterial component the required pressure to the elastomer to be pressed between the mold halves 1 and 3.

In the situation of FIG. 1D, the mold halves 1 and 3 define the volume to be filled with the flowable elastomer 5, said volume being bigger than the final volume of the ready multimaterial component. The at least mainly unsaturated elastomer suitable to be used can be raw rubber or isoprene, polybutadiene, butadiene, nitrile, ethylene, propylene, chloroprene or silicone rubber, or an alloy of those. Reinforcing agents or filling agents or agents promoting the starting or advancing of the vulcanizing reaction can be added to the elastomer or elastomer alloy to be used, one of the most preferred of those being the carbon black containing oxygen. The suitable elastomer or elastomer alloy is capable of forming a bond with each wear resistant piece of the multimaterial construction in question, but does not tend to form in the conditions required by the vulcanization process or in the operating conditions of the construction or component, independently or together with the bonded materials, reaction products detrimental to the operation of the construction or component.

FIG. 1E shows the pressing step, wherein the pressing means 4 presses the mold halves 1 and 3 with respect to each other to a position, where the volume between them corresponds to the shape and dimensions of the ready multimaterial construction or component. The holding step will be kept for the duration required by the vulcanization of the elastomer or elastomer alloy 6 brought into the increased temperature, after which the mold can be opened and the ready multimaterial construction or component can be removed from the mold. The time required by the pressing and thereby by the vulcanization is typically less than 5 minutes, preferably less than 1 minute. The temperature used during the pressing is preferably not more than 40% of the melting point temperature of the wear resistant materials (2).

FIG. 1F shows a cross-sectional view of the ready, rotationally symmetrical multimaterial component removed from the mold, having a frame 7 formed of elastomer or elastomer alloy surrounding at the predetermined portions the wear resistant pieces 2 that are positioned at optimal places based on the wear subjected to the component and the properties of the wear resistant pieces.

In the solution in accordance with the invention, the principal tasks of the elastomer acting as frame material of the wear parts are to bind the wear resistant pieces in place and to take over the mechanical load exerted on the components or parts in use and to forward the load through the supporting surfaces against it to the frame of the device acting as a fixing frame, whereby adequate strength, toughness and fatigue resistance are required from the material. The damping properties of elastomers also decrease the fatigue stress to be taken over by the frame of the equipment, and in some cases the high friction coefficient of the elastomer-metal pair resting against each other on the support surfaces decreases the relative sliding of the surfaces and the resulted wear problems of the support and mounting surfaces. The task of the wear resistant pieces in these multimaterial constructions and components is basically limited to wear resistance, whereby their properties can be chosen almost exclusively from the requirement profile based on this task. Thereby especially the hardness of the material and its capability of resisting the propagation of the wear phenomena and the related material changes typical of the conditions of the respective application, are essential requirements. When propagating, the wear phenomena would typically manifest themselves as grooving, pitting, burring, scuffing or spalling, but with wear resistant material properly chosen and treated, the occurrence of these phenomena is minor compared to other materials generally used in the application.

For the casting to assemble the wear resistant construction or component, the wear resistant pieces are cleaned of the heat affected zones caused by the primary manufacturing and the followed forming and/or machining, like oxidized layers, or impurities like cutting oil residues, all of which can have a detrimental effect on the properties of the bonding zone formed by the wear resistant pieces and the elastomer material when being bonded. The wear resistant pieces prepared for the bonding as described above, are attached to the mold so that they are kept immovably in their predetermined positions during the pouring of the elastomer material, and that the elastomer material is able to wet all the surfaces of the wear resistant pieces excluding the surface portions of the ready multimaterial construction or component opening to the outer surface thereof. On the other hand, the parameters of the vulcanizing process of the elastomer material are chosen so that the properties of the elastomer at the initial step provide an adequate wetting of all the surfaces to be bonded and the filling of the volume between the wear resistant pieces as perfectly as possible. The conditions of the vulcanizing process do not cause any significant change in the heat treatment state of the wear resistant pieces and do not promote any excessive reactions for the part of any material participating in the bond.

Multimaterial components or constructions manufactured by means of the method according to the present invention are advantageously suitable for use in wear parts in demanding applications, like for example in the equipment for crushing with a pressing or striking method of rock, building and/or recycling material and in cutting and grinding processes of wood processing.

The following benefits, among others, can be achieved by means of the solution according to the invention:
(i) By restricting the use of wear resistant material in the constructions and components only to portions, in which it is necessary in terms of wear protection, the manufacturing costs of the products in question can be decreased.
(ii) By means of the solution according to the invention, the single materials to be combined to a multimaterial component or construction can be manufactured separately with methods best suitable for their manufacturing, whereby their desired technical properties are achieved with more certainty, and as a result, the efficiency and operational reliability of the constructions and components are improved.
(iii) Easing of the dimensional and shape tolerances required by the assembly of the constructions significantly decreases the manufacturing costs.
(iv) By decreasing the use of wear resistant materials and raw materials needed for their production, the ecological efficiency of the constructions and conditions to be produced can be improved.
(v) By manufacturing the constructions and components partly (or even mainly) of lighter material, significant saving in weight can be achieved, thus decreasing the energy consumption of the equipment using the constructions and components in question and improving their applicability.
(vi) Use of vibration damping materials in constructions and components decreases the disadvantages caused by the vibration and noise.

1. Method for manufacturing a multimaterial component or construction, said method comprising the steps of:
forming at least of one wear resistant material at least one piece (2) to be positioned in a casting mold (1) of elastomer material, and
casting the elastomer or elastomer alloy in a mold (1, 3) for forming the frame of the multimaterial component or construction, whereby at least one piece (2) formed of wear resistant material attaches during the vulcanizing to said frame,
wherein at least one piece (2) manufactured of wear resistant material is attached to the frame formed of elastomer material at a temperature of not more that 40% of the melting-point temperature of the wear resistant materials (2).

2. A method in accordance with claim 1, wherein the frame formed of elastomer is made of raw rubber or isoprene, polybutadiene, butadiene, nitrile, ethylene, propylene, chloroprene or silicone rubber, or an alloy of those, that can have maximum 30 percent by volume of additional or filling materials or impurities.

3. A method in accordance with claim 1, wherein at least one piece (2) manufactured of wear resistant material is manufactured of an iron-based metal alloy having a carbon content of more than 1.9 percent by weight, hardness of more than 50 HRC, said alloy having in its microstructure a portion of more than 10% of metal carbides with a diameter of more than 3μ.

4. A method in accordance with claim 1, wherein at least one piece (2) made of wear resistant material is of hard metal including tungsten, titan, tantalum, vanadium or chrome carbides or their alloy, having as a binding agent pure or alloyed cobalt, nickel or iron so that the volumetric portion of the binding agent in the hard metal ranges from 3 to 40 percent by volume.

5. A method in accordance with claim 1, wherein the volumetric portion of the wear resistant material (2) in the multimaterial component or construction to be manufactured is more than 4%.

6. A method in accordance with claim 1, wherein the volume of the biggest single piece (2) manufactured of wear resistant material is not more than 25% of the total volume of the multimaterial component or construction.

7. A crushing process with a pressing or striking of rock, building, and/or recycling material comprising impacting the rock, building, and/or recycling material to be crushed with the multimaterial component or construction formed by the method of claim 1.

8. A process for cutting or grinding of wood comprising impacting the wood to be cut or ground with the multimaterial component or construction formed by the method of claim 1.

9. A method in accordance with claim 2, wherein at least one piece (2) manufactured of wear resistant material is manufactured of an iron-based metal alloy having a carbon content of more than 1.9 percent by weight, hardness of more than 50 HRC, said alloy having in its microstructure a portion of more than 10% of metal carbides with a diameter of more than 3μ.

10. A method in accordance with claim 2, wherein at least one piece (2) made of wear resistant material is of hard metal including tungsten, titan, tantalum, vanadium or chrome carbides or their alloy, having as a binding agent pure or alloyed cobalt, nickel or iron so that the volumetric portion of the binding agent in the hard metal ranges from 3 to 40 percent by volume.

11. A method in accordance with claim 9, wherein at least one piece (2) made of wear resistant material is of hard metal including tungsten, titan, tantalum, vanadium or chrome carbides or their alloy, having as a binding agent pure or alloyed cobalt, nickel or iron so that the volumetric portion of the binding agent in the hard metal ranges from 3 to 40 percent by volume.

12. A method in accordance with claim 2, wherein the volumetric portion of the wear resistant material (2) in the multimaterial component or construction to be manufactured is more than 4%.

13. A method in accordance with claim 3, wherein the volumetric portion of the wear resistant material (2) in the multimaterial component or construction to be manufactured is more than 4%.

14. A method in accordance with claim 4, wherein the volumetric portion of the wear resistant material (2) in the multimaterial component or construction to be manufactured is more than 4%.

15. A method in accordance with claim 9, wherein the volumetric portion of the wear resistant material (2) in the multimaterial component or construction to be manufactured is more than 4%.

16. A method in accordance with claim 10, wherein the volumetric portion of the wear resistant material (2) in the multimaterial component or construction to be manufactured is more than 4%.

17. A method in accordance with claim 2, wherein the volume of the biggest single piece (2) manufactured of wear resistant material is not more than 25% of the total volume of the multimaterial component or construction.

18. A method in accordance with claim 3, wherein the volume of the biggest single piece (2) manufactured of wear resistant material is not more than 25% of the total volume of the multimaterial component or construction.

19. A method in accordance with claim 4, wherein the volume of the biggest single piece (2) manufactured of wear resistant material is not more than 25% of the total volume of the multimaterial component or construction.

20. A method in accordance with claim 5, wherein the volume of the biggest single piece (2) manufactured of wear resistant material is not more than 25% of the total volume of the multimaterial component or construction.
